(19) United States
(12) Patent Application Publication
(10) Pub. No.: US 2015/0042783 A1
(43) Pub. Date: Feb. 12, 2015

(54) SYSTEMS AND METHODS FOR IDENTIFYING PARAMETERS FROM CAPTURED DATA

(71) Applicant: The Board of Regents, The University of Texas System, Austin, TX (US)

(72) Inventors: Raimund J. Ober, Dallas, TX (US); Yen-ching Chao, Carrollton, TX (US)

(73) Assignee: The Board of Regents, The University of Texas Syst, Austin, TX (US)

(21) Appl. No.: 14/384,626

(22) PCT Filed: Apr. 8, 2013
(86) PCT No.: PCT/US2013/035670

§ 371 Date: Sep. 11, 2014

Related U.S. Application Data
(60) Provisional application No. 61/621,539, filed on Apr. 8, 2012.

(51) Int. Cl. G02B 21/00; H04N 5/369

(52) U.S. Cl. CPC G02B 21/0032; H04N 5/369
USPC 348/80

(57) ABSTRACT

In one embodiment, identifying a parameter of interest from captured image data includes capturing image data with a signal-amplifying image detector having at least one detection element in a manner in which on average fewer than approximately 10 photons are detected by each detection element and estimating the parameter of interest from the image data with a standard deviation that is no greater than approximately 1.5 times the square root of the Cramer-Rao lower bound.

### CROSS-REFERENCE TO RELATED APPLICATION

This application claims priority to co-pending U.S. Provisional Application Ser. No. 61/621,539, filed Apr. 8, 2012, which is hereby incorporated by reference herein in its entirety.

### NOTICE OF GOVERNMENT-SPONSORED RESEARCH

This invention was made with Government support under grant contract numbers R01 GM085575 and R01 GM071048 awarded by the National Institutes of Health. The Government has certain rights in the invention.

### BACKGROUND

The accurate extraction of parameters from image data represents an important means of acquiring information in diverse fields ranging from astronomy to adaptive optics to biological microscopy. Super-localization microscopy, for example, comprises an ever-expanding set of techniques that rely on pinpointing the locations of individual fluorescent molecules for purposes such as the high-resolution reconstruction of subcellular structures and high-accuracy tracking of protein movement inside cells. Common to these techniques is the use of a pixelated light detector to record the fluorescence signal collected by the microscope and produce images from which the molecules are subsequently localized. The light detector used in the techniques is typically a charge-coupled device (CCD) detector or an electron-multiplying CCD (EMCCD) detector. Both types of detectors accumulate photoelectrons in their detection elements in proportion to the number of detected photons and produce a digitized image via a readout process. The EMCCD detector, however, has a multiplication register that amplifies the number of photoelectrons before they are read out, with the intended purpose of augmenting weak signals above the readout noise floor.

A key impediment to the localization of a feature such as a fluorescent molecule with ultrahigh accuracy is the fact that CCD and EMCCD detectors deteriorate the acquired image in two major ways. First, they pixelate the image, thereby substantially lowering its resolution. Second, they introduce noise to the image. For the CCD detector, the primary noise source is the aforementioned readout noise, which overwhelms weak signals and renders the CCD detector unsuitable for extremely low-light imaging. For the EMCCD detector, the signal amplification is also an important noise source because of its stochastic nature. Pixelation and noise can lead to localization accuracies that are substantially lower than the accuracy that is possible if the image were recorded with an ideal detector that captures it exactly as produced by the microscope.

The deteriorative effects of detector pixelation and noise become especially consequential under low-light conditions. Even in the absence of pixelation and noise, the accuracy of localization that can be expected is relatively poor when only low numbers of photons can be detected. This directly follows from the well-known fact that estimation accuracies worsen with decreasing photon count. However, in many practical situations, low photon counts are unavoidable or necessary. In super-resolution microscopy, relatively weak fluorophores often need to be chosen because they possess desirable attributes that brighter fluorophores lack. Examples include the preferred use of weak genetically encoded fluorescent proteins for their labeling specificity and the selection of weak dyes in multicolor super-resolution imaging based on, for instance, the necessity of using spectrally well-separated fluorophores. Moreover, in live-cell super-resolution imaging and single-molecule tracking, even the use of bright fluorophores typically results in low-photon-count images owing to the fast acquisition rate that is required to follow the dynamics of the cellular structures and molecules. More generally, to minimize phototoxicity and at the same time maximize the duration over which samples can be imaged using the many conventional dyes and fluorescent proteins that have limited photostability, microscopists might even wish to purposely acquire low-photon-count images using low excitation power levels. The extension of imaging time is of particular importance for single-molecule tracking, as then substantially longer trajectories can potentially be observed.

From the above discussion, it can be appreciated that it would be desirable to have a system and method for more accurately identifying parameters, such as feature locations, from image data captured by a light detector.

### BRIEF DESCRIPTION OF THE DRAWINGS

The present disclosure may be better understood with reference to the following figures. Matching reference numerals designate corresponding parts throughout the figures, which are not necessarily drawn to scale.

FIG. 1 is an embodiment of a system for identifying parameters from captured image data.

FIG. 2A is an ultrahigh accuracy imaging modality (UAIM) image of a 50-nm fluorescent bead having a mean photon count in the brightest pixel of 0.30.

FIG. 2B is a mesh view of the image of FIG. 2A.

FIG. 3A is a conventional electron-multiplying charge-coupled device (EMCCD) image of a 50-nm fluorescent bead having a mean photon count in the brightest pixel of 16.84.

FIG. 3B is a mesh view of the image of FIG. 3A.

FIG. 4A is a graph that compares the standard deviation of maximum-likelihood estimates of the x₀ coordinate of fluorescent beads imaged using UAIM and conventional imaging. Each standard deviation corresponds to a different bead that is identified by its per-image mean photon count. For each standard deviation, the corresponding limit of accuracy is shown. Likewise, the corresponding ultimate limit of accuracy, which assumes an ideal detector that introduces neither noise nor pixelation, is shown. The UAIM and conventional images were acquired with effective pixel sizes of 16 and 253.97 nm using 1,000× and 63× magnifications, respectively.

FIG. 4B is a graph of theoretical analysis of point source localization. Decreasing the effective pixel size by increasing the magnification for EMCCD imaging at a high level of signal amplification (electron multiplication gain of 1,000) yields a limit of accuracy that approaches the ultimate limit. The larger markers at effective pixel sizes of 373.31, 224.00, and 160.00 nm (magnifications of 42.86, 71.43, and 100) approximately correspond to standard magnifications of 40× and 63× and exactly correspond to the standard magnification of 100×. For the same range of effective pixel sizes, the limits of accuracy corresponding to the common excess noise-based supposition and to CCD imaging with a readout noise standard deviation of 0.5 electron per pixel are shown.

FIG. 5A is an image of an Alexa 647-labeled LAMP1⁺ cellular structure formed by summing 5,063 UAIM images of the stochastically activated Alexa 647 molecules.

FIG. 5B is a super-resolution image of the structure of FIG. 5A constructed from location estimates of the individual Alexa 647 molecules from the same 5,063 UAIM images.

### DETAILED DESCRIPTION

As described above, it would be desirable to have a system and method for more accurately identifying parameters from data captured by a light detector. Disclosed herein are examples of such systems and methods. In some embodiments, the systems and methods implement an ultrahigh accuracy imaging modality (UAIM) in which image data is captured and parameters of interest are estimated from the data using an appropriate technique, such as maximum-likelihood estimation. In some embodiments, light is captured with a light detector in a manner in which, on average, less than one photon is detected by each detection element of the detector. This condition can naturally result from very low amounts of light being available for imaging or can be intentionally created in order to use UAIM. Unexpectedly, much greater accuracy in the parameter estimation can be achieved with the very low photon count per detection element image data than can be obtained with more conventional image data. While UAIM can be used to great advantage in object (e.g., fluorescent molecule) localization, its use extends to many other applications, such as estimation of the distance between two objects, object trajectory estimation, and high-quality image production. Further, the applicability of UAIM is not limited to light detectors that produce image data. UAIM can be applied to both light detectors and non-light detectors that produce data not generally regarded as images.

In the following disclosure, various specific embodiments are described. It is to be understood that those embodiments are example implementations of the disclosed inventions and that alternative embodiments are possible. All such embodiments are intended to fall within the scope of this disclosure.

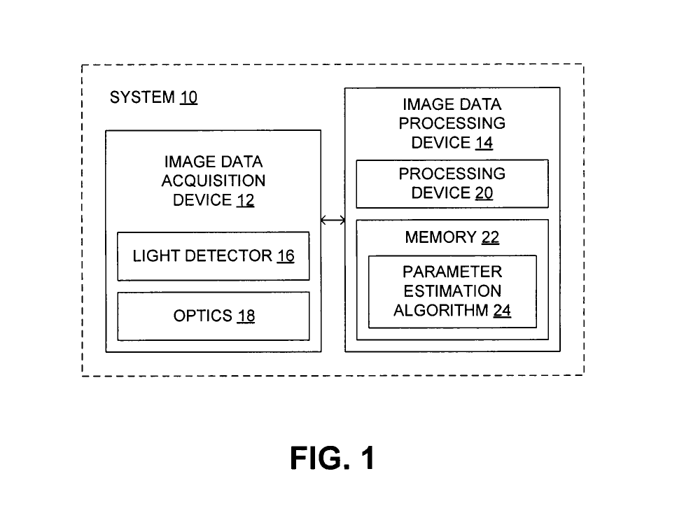

As described above, it has been discovered that greater parameter estimation accuracy can be achieved when very low numbers of photons are detected per element of a light detector and the resulting image data is processed in a desirable manner. FIG. 1 illustrates an example system 10 for identifying parameters from captured image data and, more particularly, for performing UAIM. As indicated in FIG. 1, the system 10 generally comprises an image data acquisition device 12 and an image data processing device 14. While these two devices 12, 14 are illustrated as being independent of each other, it is noted that, in some embodiments, they can be combined into a single integrated device. In such a case, the “system” 10 is the integrated device. Examples of integrated devices include a microscope or telescope integrated with a camera and/or additional optical components such as magnifiers, and further integrated with data processing hardware and software that implement a parameter estimation algorithm. Other examples include a Shack-Hartmann wavefront sensor, a night vision device, or a consumer digital camera integrated with optical components such as magnifiers, and further integrated with data processing hardware and software that perform the parameter estimation.

As shown in FIG. 1, the image data acquisition device 12 generally includes one or more light detectors 16 and optics 18 (e.g., one or more lenses) that are used to focus light on the detector(s). In some embodiments, the image data acquisition device 12 includes a pixelated detector that comprises numerous detection elements that can independently detect incident photons. By way of example, the light detector 16 can comprise a charge-coupled device (CCD) or an electron-multiplying CCD (EMCCD) detector having many hundreds of thousands of detection elements. In other embodiments, however, the light detector 16 can comprise a single detection element that can be used in conjunction with a scanning mechanism to capture a viewed scene. Examples of such detectors include an avalanche photodiode and a photomultiplier tube (PMT). In some embodiments, the image data acquisition device 12 can include multiple light detectors 16. Irrespective of the nature of the light detector(s) 16, the image data acquisition device 12 is used within UAIM to capture image data in which a limited number of photons are detected by each detection element. As described below, this result can be achieved in a variety of different ways.

With further reference to FIG. 1, the image data processing device 14 generally includes a processing device 20 (e.g., a field-programmable gate array (FPGA)) and memory 22 (a non-transitory computer-readable medium) that includes one or more programs and/or algorithms (logic) that are configured to estimate one or more parameters from the image data received from the image data acquisition device 12. In the illustrated embodiment, the memory 22 stores a parameter estimation algorithm 24. As described below, the parameter estimation algorithm 24 can, in some embodiments, comprise a maximum-likelihood algorithm that is configured to estimate one or more parameters of interest by maximizing a function.

As described above, UAIM employs an image acquisition modality whereby the photons detected during the acquisition process are distributed over the detection elements of the light detector such that a very low number of photons are detected by each detection element of the detector. In some embodiments, an average of fewer than approximately 10 photons are detected by each detection element. In other embodiments, an average of fewer than approximately 5 photons are detected by each detection element. In further embodiments, an average of fewer than approximately 3 photons are detected by each detection element. In still other embodiments, an average of fewer than approximately 1 photon is detected by each detection element. When image data having such low photon counts is captured, the corruption of the signal in each detection element from detector noise (i.e., readout noise and the stochasticity of the signal amplification process) is significantly reduced and the amount of information that the image data contains about the parameters of interest is significantly increased. Accordingly, the parameters of interest can be estimated from the image data set with substantially higher accuracies than those that could be expected with a conventionally acquired image data set. Some implementations of UAIM can achieve accuracies approaching the accuracy that could only be obtained if one had an ideal image that contained no detector noise and had arbitrarily high resolution (i.e., unpixelated). Using these implementations, the best possible standard deviation (determined using the theory of the Cramer-Rao lower bound) approaches the ultimate best possible standard deviation of the ideal image scenario.

The low photon counts per detection element used in UAIM can result naturally from the conditions in which the image data is acquired. For example, the light that is available in a particular case may be very low, in which case a relatively small number of photons will be detected by each detection element of the light detector. In other cases, however, the effective element size of the detector can be intentionally reduced. This can be achieved in a variety of ways. In some embodiments, unconventionally large magnification can be used to spread out the photons emitted by an object of interest over the elements of the light detector. In fluorescence microscopy, for example, if a standard magnification of 100× yields an average photon count of 10 for the brightest pixel of an image, then one might use a magnification of 1000× to achieve an average photon count of just 0.1 for the brightest pixel. In other embodiments, a light detector having unconventionally small elements can be used to ensure that each element only detects a small number of photons. For example, if using a standard EMCCD detector with a 16-μm pixel size yields an average photon count of 10 for the brightest pixel of an image, then one might use an EMCCD detector with a 1.6-μm pixel size to achieve an average photon count of just 0.1 for the brightest pixel. In other embodiments, multiple images can be captured in succession to temporally distribute the photons and thereby reduce the number of photons detected by each element at any one time. For example, if an image acquired over a 400-ms exposure has an average photon count of 5 in its brightest pixel, then one might instead acquire ten images over a 400-ms interval such that each of the ten images is captured using a 40-ms exposure and has an average photon count of just 0.5 in its brightest pixel. In still other embodiments, multiple light detectors can be used to simultaneously acquire images of the object (e.g., as in multifocal plane microscopy (MUM) in which multiple detectors are simultaneously used to image different focal planes in the sample) so as to distribute the photons across the detection elements of the multiple detectors. In further embodiments, one or more point detectors having a single detection element can be used, along with a scanning mechanism, to acquire images of the object. In still further embodiments, a combination of the above methods can be implemented.

It is noted that by virtue of the improved image resolution that is gained, the use of an unconventionally high magnification can also be used to obtain high parameter estimation accuracies with non-signal-amplifying light detectors such as a CCD detector or a scientific complementary metal-oxide semiconductor (sCMOS) detector. It is further noted that, while great improvement in the accuracy for estimating a parameter of interest is achieved by detecting a low average number of photons (e.g., fewer than 1 photon) with each detection element, a substantial improvement in parameter estimation accuracy can be achieved even if some detection elements in the image data have a mean photon count that is greater. To demonstrate this, Table 1 shows, for mean photon counts ranging from 200 to 3,200 per image of a point source, the limits of accuracy (i.e., theoretical best possible standard deviation given by the square root of the Cramer-Rao lower bound) for determining the x₀ coordinate of a point source. For each of the five mean photon counts, the limit of accuracy when the point source is imaged using UAIM (at a 900× magnification) is significantly better than the limit of accuracy when it is imaged using conventional EMCCD imaging (at a 100× magnification). Furthermore, in each case the UAIM limit of accuracy is close to its corresponding ultimate limit of accuracy, which can only be achieved if the image is captured using an ideal detector that introduces neither pixelation nor noise. Importantly, significant improvement in accuracy is gained in the scenarios in which the per-image mean photon count is 400 or higher, despite the fact that in each of those cases some pixels in the image have a mean photon count that is greater than 1. For example, when the mean photon count detected from the point source is 3,200, nearly 13% of the pixels in the image have a mean photon count greater than 1, and the brightest pixel has a mean photon count of 12.49.

TABLE 1
UAIM at different photon budgets

| | | Conventional | |
|---|---|---|---|
| | Ultimate limit of | EMCCD limit | UAIM limit of |
| Mean photon | accuracy | of accuracy | accuracy |
| count | (nm) | (nm) | (nm) |
| 200 | 6.19 | 11.72 | 6.81 |
| 400 | 4.38 | 8.39 | 4.90 |
| 800 | 3.10 | 5.99 | 3.56 |
| 1600 | 2.19 | 4.26 | 2.60 |
| 3200 | 1.55 | 3.02 | 1.90 |

Irrespective of the acquisition method that is used, the resulting image data (UAIM data) includes one or more measurements from one or more detection elements in which the mean photon count in each detection element is very low, for example, on average less than 1. In some cases, the UAIM data comprises a single image of the object of interest. By way of example, the image can be a single high-magnification image or a single normal-magnification image with unconventionally small pixel sizes. In other cases, the UAIM data comprises a set of images of the same object of interest. By way of example, the data can be a set of images that were sequentially acquired using a single image detector, each with a small exposure time or a set of images that were simultaneously and/or sequentially acquired using multiple image detectors. In still other cases, the UAIM data comprises readings from point detectors that employ photon multiplication. By way of example, the data can be detector measurements that can be used to determine the spatial location of a fluorescent object.

Once the UAIM data has been acquired, it can be processed to identify the parameter or parameters of interest. In some embodiments, the parameters are estimated using the parameter estimation algorithm 24 identified above in relation to FIG. 1. The parameter estimation algorithm can take various forms to achieve varying levels of accuracy in estimating the parameters of interest. In some embodiments, the parameter estimation algorithm comprises a maximum-likelihood algorithm that can numerically attain, or nearly attain, the theoretical best possible accuracy (determined using the theory of the Cramer-Rao lower bound). In the following paragraphs, an example maximum-likelihood algorithm is described.

The data collected in each element of a light detector that stochastically amplifies its detected signals (e.g., an EMCCD detector) can be modeled as the sum of an amplified Poisson signal and a Gaussian random variable representing the device's readout noise. As such, given an image or set of images composed of a total of K detection elements, the maximum-likelihood estimation of the parameters of interest is carried out by maximizing the log-likelihood function

$$ln ( L ( θ \vert {z}_{1} , … , {z}_{K} ) ) = {\sum }_{k = 1}^{K} ln ( {p}_{θ , γ , k} ( {z}_{k} ) ) , \qquad [ Equation 1 ]$$

where θ is the vector of the parameters to be estimated (including the parameters of interest and any auxiliary parameters that are unknown), and for k=1, . . . , K, zₖ is the data at the kth detection element, and p_{θ,γ,k} is the probability density function of zₖ. The subscript γ in p_{θ,γ,k} denotes the detector containing the kth detection element, which can be different from other detectors that were used to capture the UAIM data in terms of the wavelength of the photons that were detected, the magnification at which the acquisition was carried out, the focal plane within the imaged sample that was captured, and the signal amplification gain that was used for the acquisition. In performing the estimation, the log-likelihood function is iteratively evaluated with different values for the parameters in θ, and the particular values that maximize the log-likelihood function provide the best estimate of the parameters.

The expression for the probability density function p_{θ,γ,k} in Equation 1 depends on the particular model that is used to describe the detector's stochastic signal amplification. For example, assuming signal amplification modeled by a zero-modified, geometrically-multiplied branching process, the function p_{θ,γ,k} is given by

$${p}_{θ , γ , k} ( z ) = \frac{{e}^{- {v}_{θ , γ} ( k , {t}_{k} ) \frac{{A}_{γ}}{{Q}_{γ}}}}{\sqrt{2 π} {σ}_{γ , k}} [ {e}^{- {( \frac{z - {η}_{γ , k}}{\sqrt{2} {σ}_{γ , k}} )}^{2}} + {\sum }_{l = 1}^{∞} {e}^{- {( \frac{z - l - {η}_{γ , k}}{\sqrt{2} {σ}_{γ , k}} )}^{2}} {\sum }_{j = 0}^{l - 1} \frac{( \begin{matrix}l - 1 \\ j\end{matrix} ) {{H}_{γ}^{l - j - 1} ( {D}_{γ} {v}_{θ , γ} ( k , {t}_{k} ) )}^{j + 1}}{( j + 1 ) ! {Q}_{γ}^{j + l + 1}} ] , \qquad [ Equation 2 ]$$

z ∈ R, where A_{γ}=(1-a_{γ})(m_{γ}-1) g_{γ}, Q_{γ}=q_{γ} (g_{γ}-1)m_{γ}+(1-a_{γ})(m_{γ}-1), H_{γ}=q_{γ} (g_{γ}-1)m_{γ}, D_{γ}=g_{γ} (1-a_{γ})²(m_{γ}-1)², m_{γ}=(1-a_{γ})/(1-q_{γ})≠1, 0≦a_{γ}, q_{γ}<1, g_{γ}=(m_{γ})̂N, where N is the number of multiplicative gain stages in the light detector, g_{γ} is the signal amplification gain of the image detector, η_{γ,k} and σ_{γ,k} are, respectively, the mean and standard deviation of the Gaussian readout noise for the kth detection element, and the function ν_{θ,γ}(k,tₖ) gives the mean of the Poisson signal (i.e., photon count) detected in the kth detection element during the acquisition time interval [t_{0,k}, tₖ]. The function v_{θ,γ}(k,tₖ) is generally given by

ν_{θ,r}(k,tₖ)=∫ₜ_{_{0,k}}^{t}^{ₗ}∫_{C}_{ₖ}Λ_{θ,γ}(τ) ƒ_{θ,γ,τ}(x, t)dxdyd τ+∫ₜ_{_{0,k}}^{t}^{ₖ}∫_{C}_{ₖ}β_{θ,γ,τ}(x, y)dxdyd τ, [Equation 3]

where Cₖ is the region in the detector plane of detector γ occupied by the kth detection element, the function A_{θ,γ} gives the rate at which photons are detected from the object(s) over the entire detector plane (i.e., R²) of detector γ, the function β_{θ,γ} gives the rate at which background photons are detected, and the functions ƒ_{θ,γ,τ} and b_{θ,γ,τ} are the probability density functions that respectively describe the spatial distributions of the photons originating from the object(s) of interest and the background photons. The definitions for the functions A_{θ,γ}, ƒ_{θ,γ,τ}, β_{θ,γ}, and b_{↓,γ,τ} respectively depend on the modeling of the object photon detection rate, the object photon distribution, the background photon detection rate, and the background photon distribution. These functions can be customized for the specific application at hand. Example applications are described below.

Rather than being estimated simultaneously with the parameters of interest, auxiliary parameters can be determined separately with appropriate methods and used as fixed (i.e., known) values in the maximum-likelihood estimation. The object photon detection rate Λ_{θ,γ} and the background photon detection rate β_{θ,γ}, for example, are auxiliary parameters that can be estimated separately and used as fixed values in the maximum-likelihood estimation. Assuming they are constant rates, for example, they can be determined in the following ways. In the case where the data consists of just a single high magnification image, the pixels of the image can be binned to produce a “compacted” image that resembles a conventionally acquired image. From the compacted image, an algorithm such as nonlinear least squares estimation can be used with an appropriate model for the image to obtain estimates of the rates. In the case where the data is a set of multiple (e.g., successively acquired) images of the same stationary object(s), the images forming the set can be added to produce a sum image that resembles a conventionally acquired image. From the sum image, an algorithm such as nonlinear least squares estimation can again be used to determine the rates.

The described maximum-likelihood estimation can be implemented by minimizing the negative of the log-likelihood function (Equation 1) using any minimization approach.

As mentioned above, maximum likelihood estimation can numerically attain, or nearly attain, the theoretical best possible accuracy. More specifically, this benchmark accuracy is the theoretical best possible standard deviation given by the square root of the Cramer-Rao lower bound for estimating the particular parameter. Given the vector θ of the parameters to be estimated, the square root of the Cramer-Rao lower bound for estimating the ith parameter in θ is √[I⁻¹(θ)]ᵢᵢ, where [I⁻¹(θ)]ᵢᵢ is the ith main diagonal element of the inverse of the Fisher information matrix I(θ) for the image or set of images comprising K detection elements. The Fisher information matrix I(θ) is given by

$$I ( θ ) = {\sum }_{k = 1}^{K} {( \frac{\partial {v}_{θ , γ} ( k , {t}_{k} )}{\partial θ} )}^{T} \frac{\partial {v}_{θ , γ} ( k , {t}_{k} )}{\partial θ} \cdot E [ ( \frac{\partial }{\partial {v}_{θ , γ} ( k , {t}_{k} )} ) {ln ( {p}_{θ , γ , k} ( Z ) )}^{2} ] \qquad [ Equation 4 ]$$

where the function p_{θ,γ,k} is given by Equation 2, the function ν_{θ,γ}(k,tₖ) is given Equation 3, the symbol T denotes the transpose, and the symbol E denotes the expectation.

It is noted that the described maximum-likelihood algorithm and theoretical benchmark accuracy applies as well to image data that results from the use of an unconventionally high magnification with one or more non-signal-amplifying light detectors such as the CCD detector and the sCMOS detector. In such a scenario, the probability density function of Equation 2 is replaced by

$${p}_{θ , γ , k} ( Z ) = \frac{1}{\sqrt{2 π} {σ}_{y , k}} {\sum }_{j = 0}^{∞} \frac{{e}^{- v θ , γ} ( k , {t}_{k} )}{j !} {e}^{- \frac{1}{2} {( \frac{z - j - {η}_{γ , k}}{{σ}_{γ , k}} )}^{2}}$$

z ∈ R, where all symbols are as defined for Equation 2.

As expressed above, the functions of Equation 3 can be customized for particular applications and particular parameters of interest. One UAIM application is imaging a stationary object from a single plane of focus. In such a case, the UAIM data comprises one or more images of stationary objects of interest. In the case of multiple images, the images capture the same focal plane within the sample and can be sequentially captured by the same light detector, simultaneously by different light detectors, or by a combination of both. In such a scenario, a point source can be localized or the distance between two point sources can be estimated.

In the case of point source localization in microscopy, the UAIM data comprises one or more images (total of K detection elements) of a stationary point source. The parameters of interest are the x₀ and y₀ positional coordinates of the point source if the point source is located in the plane of focus of the microscopy setup, and the x₀, y₀, and z₀ positional coordinates of the point source if the point source is located outside the plane of focus of the microscopy setup. Accordingly, the vector of parameters to be estimated is θ=(x₀, y₀) for the in-focus scenario, and θ=(x₀, y₀, z₀) for the out-of-focus scenario.

Assuming a constant detection rate for photons originating from the point source throughout the image acquisition, the function A_{θ,γ} is given by A_{θ,γ}(τ)=Λ₀, τ≧t₀, where Λ₀ is some positive number. Similarly, assuming a constant detection rate for background photons throughout the image acquisition, the function β_{θ,γ} is given by β_{θ,γ}(τ)=β₀, τ≧t₀, where β₀ is some positive number.

Assuming the point source is in-focus and the photons detected from it form a pattern described by the Airy point spread function (other possibilities include the Gaussian point spread function for the in-focus scenario, and the Born-Wolf point spread function (see Equation 9), the Gibson-Lanni point spread function, and vectorial diffraction theory-based point spread functions for the out-of-focus scenario), the spatial probability density function f_{θ,γ,τ} for the kth detection element, k=1, . . . , K, is given by

$${f}_{θ , γ} ( x , y ) = \frac{1}{{M}_{γ}^{2}} \frac{{J}_{1}^{2} ( \frac{2 π {n}_{a}}{λ} \sqrt{{( \frac{x}{{M}_{γ}} - {x}_{0} )}^{2} + {( \frac{y}{{M}_{γ}} - {y}_{0} )}^{2}} )}{π [ {( \frac{x}{{M}_{γ}} - {x}_{0} )}^{2} + {( \frac{y}{{M}_{γ}} - {y}_{0} )}^{2} ]} , \qquad [ Equation 5 ]$$

(x, y) ∈ R², where λ is the wavelength of the detected photons, nₐ is the numerical aperture of the microscopy setup used to image the point source, M_{γ} is the magnification at which the image containing the kth detection element was captured, and J₁ is the first order Bessel function of the first kind. Because the point source is assumed to be stationary, Equation 5 is independent of time τ and the subscript τ is dropped from ƒ_{θ,γ,τ}.

Assuming that background photons are uniformly distributed over each detector γ, the spatial probability density function b_{θ,γ,τ} for the kth detection element, k=1, . . . , K, is given by

$${b}_{θ , γ} ( x , y ) = \frac{1}{{ζ}_{γ}} , \qquad [ Equation 6 ]$$

where ζ_{γ} is the area of detector γ.

Given the assumptions described above, the mean of the number of photons detected in the kth detection element during the acquisition time interval [t_{0,k}, tₖ], k=1, . . . , K, reduces to the more explicit expression

$${v}_{θ , γ} ( k , {t}_{k} ) = {Λ}_{0} ( {t}_{k} - {t}_{0 , k} ) {\int }_{{C}_{k}} {f}_{θ , γ} ( x , y ) d x d y + \frac{{β}_{0} ( {t}_{k} - {t}_{0 , k} )}{{ζ}_{γ}} {\int }_{{C}_{k}} d x d y , \qquad [ Equation 7 ]$$

where f_{θ,γ} is given by Equation 5.

In the case of point source distance estimation, the UAIM data comprises one or more images of two stationary point sources. If both point sources are located in the plane of focus of the image data acquisition device (e.g., a microscopy setup), the vector of parameters to be estimated is θ=(d, sₓ, s_{y}, φ), where d is the distance between the two point sources, sₓ and s_{y} are the x and y positional coordinates of the midpoint between the two point sources, and φ is the angle between the line joining the two point sources and the positive x-axis of the coordinate system. If one or both point sources are located outside the plane of focus of the microscopy setup, the vector of parameters to be estimated is θ=(d, sₓ, s_{y}, s_{z}, φ, ω), where the additional parameter s_{z} is the z positional coordinate of the midpoint between the two point sources, φ is the angle that the xy-plane projection of the line joining the two point sources forms with the positive x-axis, and the additional parameter ω is the angle that the line joining the two point sources forms with the positive z-axis.

The function Λ_{θ,γ} is generally given by Λ_{θ,γ}(τ)=Λ₁(τ)+Λ₂(τ), τ≧t₀, where Λ₁ and Λ₂ are the photon detection rates for the two point sources. Assuming the same constant detection rate for photons originating from each point source throughout the image acquisition, Λ_{θ,γ} is reduced to Λ_{θ,γ}=2·Λ₀, τ≧t₀, where Λ₀ is a positive number specifying the photon detection rate for each point source.

Assuming a constant detection rate for background photons throughout the image acquisition, the function β_{θ,γ} is given by β_{θ,γ}(τ)=β₀, τ≧t₀, where β₀ is some positive number.

Assuming both point sources are in-focus and the photons detected from each form a pattern described by the Airy point spread function (other possibilities include the Gaussian point spread function for the in-focus scenario, and the Born-Wolf point spread function (see Equation 9), the Gibson-Lanni point spread function, and vectorial diffraction theory-based point spread functions for the out-of-focus scenario), the spatial probability density function ƒ_{θ,γ,τ} for the kth detection element, k=1, . . . K, is given by the scaled sum of two Airy point spread functions:

$${f}_{θ , γ} ( x , y ) = \frac{1}{2 {M}_{γ}^{2}} [ \frac{{J}_{1}^{2} ( \frac{2 π {n}_{a}}{λ} \sqrt{\begin{matrix}{( \frac{x}{{M}_{γ}} - {s}_{x} - \frac{d}{2} cos ϕ )}^{2} + \\ {( \frac{y}{{M}_{γ}} - {s}_{γ} - \frac{d}{2} sin ϕ )}^{2}\end{matrix}} )}{π [ \begin{matrix}{( \frac{x}{{M}_{γ}} - {s}_{x} - \frac{d}{2} cos ϕ )}^{2} + \\ {( \frac{y}{{M}_{γ}} - {s}_{γ} - \frac{d}{2} sin ϕ )}^{2}\end{matrix} ]} + \frac{{J}_{1}^{2} ( \frac{2 π {n}_{a}}{λ} \sqrt{\begin{matrix}{( \frac{x}{{M}_{γ}} - {s}_{x} + \frac{d}{2} cos ϕ )}^{2} + \\ {( \frac{y}{{M}_{γ}} - {s}_{γ} + \frac{d}{2} sin ϕ )}^{2}\end{matrix}} )}{π [ \begin{matrix}{( \frac{x}{{M}_{γ}} - {s}_{x} + \frac{d}{2} cos ϕ )}^{2} + \\ {( \frac{y}{{M}_{γ}} - {s}_{γ} + \frac{d}{2} sin ϕ )}^{2}\end{matrix} ]} ] , \qquad [ Equation 8 ]$$

(x, y) ∈ R², where the various parameters are as defined for Equation 5. Equation 8 is independent of time τ and therefore the subscript τ is dropped from ƒ_{θ,γ,τ}.

Assuming that background photons are uniformly distributed over each detector γ, the spatial probability density function b_{θ,γ,τ} for the kth detection element, k=1, . . . , K, is given by Equation 6.

Given the assumptions described above, the mean of the detected photon count in the kth detection element, k=1, . . . , K, reduces to Equation 7 with ƒ_{θ,γ} given by Equation 8.

A second UAIM application is that of stationary objects imaged from multiple planes of focus. In such an application, the UAIM data comprises multiple images capturing the same stationary objects of interest from different planes of focus. The images can be sequentially captured by the same light detector, simultaneously captured by different light detectors that image different planes of focus as in MUM, or captured by a combination of both. Using this data, an object can be localized or the distances between objects can be estimated.

In the case of point source localization, the UAIM data comprises multiple images and K detection elements of a stationary point source. Each image captures the point source from a different plane of focus. The parameters of interest are the x₀, y₀, and z₀ positional coordinates of the point source. Accordingly, the vector of parameters to be estimated is θ=(x₀, y₀, z₀).

Assuming a constant detection rate for photons originating from the point source throughout the image acquisition, the function Λ_{θ,γ} is given by Λ_{↓,γ}(τ)=Λ₀, τ≧t₀, where Λ₀ is some positive number. Similarly, assuming a constant detection rate for background photons throughout the image acquisition, the function β_{θ,γ} is given by β_{θ,γ}(τ)=β₀, τ≧t₀, where β₀ is some positive number.

Assuming the photons detected from the point source form a pattern described by the Born-Wolf point spread function (other possibilities include the Gibson-Lanni point spread function and vectorial diffraction theory-based point spread functions), the spatial probability density function ƒ_{θ,γ,τ} for the kth detection element, k=1, . . . , K, is given by

$${f}_{θ , γ} ( x , y ) = \frac{4 π {n}_{a}^{2}}{{λ}^{2} {M}_{γ}^{2}} {\vert {\int }_{0}^{1} {J}_{0} ( \frac{2 π {n}_{a}}{λ} \sqrt{\begin{matrix}{( \frac{x}{{M}_{γ}} - {x}_{0} )}^{2} + \\ {( \frac{y}{{M}_{γ}} - {y}_{0} )}^{2}\end{matrix}} ρ ) {e}^{j \frac{π {n}_{a}^{2} ( {z}_{0} - {δ}_{r} )}{n λ}} ρ d ρ \vert}^{2} , \qquad [ Equation 9 ]$$

(x, y) ∈ R², where n is the refractive index of the microscope objective immersion medium, J₀ is the zeroth order Bessel function of the first kind, and the other parameters are as defined for Equation 5. Note that the positional coordinate z₀ is adjusted by δ_{γ} to account for the distance between the plane of focus for the particular detector γ and the reference plane of focus (which has δ_{y}=0). By providing information from additional planes of focus, the use of a MUM setup enables one to overcome the depth discrimination problem, which prevents the accurate estimation of the z₀ parameter of a near-focus point source using a conventional single plane of focus setup. Equation 9 is independent of time τ, and therefore the subscript τ is dropped from ƒ_{θ,γ,τ}.

Assuming that background photons are uniformly distributed over each detector γ, the spatial probability density function b_{θ,γ,τ} for the kth detection element, k=1, . . . , K, is given by Equation 6.

Given the assumptions described above, the mean of the detected photon count in the kth detection element, k=1, . . . , K, reduces to Equation 7 with ƒ_{θ,γ} given by Equation 9.

In the case of point source distance estimation, a MUM setup also enables one to overcome the depth discrimination problem in estimating the distance between two point sources. The details for the realization are analogous to those described above in relation to stationary objects imaged from a single plane of focus, but using, for example, the Born-Wolf point spread function of Equation 9 to model the image of each point source.

A third UAIM application involves the trajectories of moving objects. In such an application, the UAIM data comprises one or more images of a moving object of interest. The images capture the same focal plane within the sample and can be sequentially acquired by one or more image detectors. In the latter case, the multiple detectors can acquire the images in synchrony or in asynchrony, wherein the acquisition time intervals for some images are partially overlapping.

In two-dimensional trajectory estimation involving a point source, the UAIM data comprises one or more images of a point source moving in, for example, a linear trajectory at constant speed. Assuming that the linear trajectory of the point source is confined to the plane of focus of the image data acquisition device (e.g., microscopy setup), the parameters of interest are the constant speed μ, the x₀ and y₀ positional coordinates of the initial location of the point source, and the direction of movement φ (i.e., angle between the linear trajectory and the positive x-axis). Accordingly, the vector of parameters to be estimated is θ=(μ, x₀, y₀, φ).

Assuming a constant detection rate for photons originating from the point source throughout the image acquisition, the function Λ_{θ,γ} is given by Λ_{θ,γ}(τ)=Λ₀, τ≧t₀, where Λ₀ is some positive number. Similarly, assuming a constant detection rate for background photons throughout the image acquisition, the function β_{θ,γ} is given by β_{θ,γ}(τ)=β₀, τ≧t₀, where β₀ is some positive number.

Assuming the photons detected from the point source form a pattern described by the Airy point spread function (other possibilities include the Gaussian point spread function), the spatial probability density function ƒ_{θ,γ,τ} for the kth detection element, during the acquisition time interval [t_{0,k}, tₖ], k=1, . . . , K, is given by

$${f}_{θ , γ , τ} ( x , y ) = \frac{1}{{M}_{γ}^{2}} \frac{{J}_{1}^{2} ( \frac{2 π {n}_{a}}{λ} \sqrt{{( \frac{x}{{M}_{γ}} - {x}_{θ} ( τ ) )}^{2} + {( \frac{y}{{M}_{γ}} - {y}_{θ} ( τ ) )}^{2}} )}{π [ {( \frac{x}{{M}_{γ}} - {x}_{θ} ( τ ) )}^{2} + {( \frac{y}{{M}_{γ}} - {y}_{θ} ( τ ) )}^{2} ]} , \qquad [ Equation 10 ]$$

(x, y) ∈ R², where x₀(τ)=x₀+μ(τ-t_{0,k})cos(φ) and y₀(τ)=y₀+μ(τ-t_{0,k})sin(φ), t_{0,k}≦τ≦tₖ, and the other parameters are as defined for Equation 5. It is noted that, by defining x_{θ}(τ) and y₀(τ) differently, Equation 10 can be used for the estimation of parameters corresponding to other types of trajectories. For example, by defining x_{θ}(τ) and y_{θ}(τ) appropriately, parameters such as the radius and angular velocity of a circular trajectory can be estimated.

Assuming that background photons are uniformly distributed over each detector γ, the spatial probability density function b_{θ,γ,τ} for the kth detection element, k=1, . . . , K, is given by Equation 6.

Given the assumptions described above, the mean of the number of photons detected in the kth detection element during the acquisition time interval [t_{0,k}, tₖ], k=1, . . . , K, reduces to the more explicit expression

$${v}_{θ , γ} ( k , {t}_{k} ) = {Λ}_{0} {\int }_{{t}_{0 , k}}^{{t}_{k}} {\int }_{{C}_{k}} {f}_{θ , γ , τ} ( x , y ) d x d y d τ + \frac{{β}_{0} ( {t}_{k} - {t}_{0 , k} )}{{ζ}_{γ}} {\int }_{{C}_{k}} d x d y , \qquad [ Equation 11 ]$$

where ƒ_{θ,γ,τ} is given by Equation 10.

The above methodology can be modified in straightforward fashion for estimation involving a trajectory not confined to the plane of focus, i.e., for three-dimensional trajectory estimation. The details for the realization are analogous but entail, for example, the use of the Born-Wolf point spread function to model the image of the point source, and in the case of a linear trajectory, the addition of the z₀ positional coordinate of the initial location of the point source and the angle ω between the trajectory and the positive z-axis as parameters to be estimated.

A fourth UAIM application is that of high-quality image production. In such a case, the UAIM data comprises a single image or multiple images of the same stationary scene, acquired sequentially or simultaneously using one or more light detectors. The parameters to be estimated comprise a statistic of the photon counts that would be detected in the detection elements of the equivalent conventional image(s) or comparable conventional image(s). Assume that a high-quality image is to be constructed from the mean photon counts in the K detection elements of a conventional image. The vector of parameters to be estimated is then simply the value of the functions ν_{θ,γ}(k,t) of Equation 3, k=1, . . . , K, themselves: θ=(ν_{θ,γ}(1, t₁), ν_{θ,γ}(2, t₂), . . . , ν_{θ,γ}(K, t_{K})). The functions Λ_{θ,γ}, ƒ_{θ,γ}, β_{θ,γ}, and b_{θ,γ,τ} do not need to be defined because, in this application, the values of the functions ν_{θ,γ}(k, tₖ) are directly estimated.

Rather than estimating θ=(ν_{θ,γ}(1, t₁), ν_{θ,γ}(2, t₂), . . . , ν_{θ,γ}(K, t_{K})) from the conventional image, UAIM can be used such that the estimation of θ is carried out on an image obtained by distributing (temporally or spatially) the photons in each of the K pixels of the conventional image over c pixels, where c is a positive integer greater than 1. Compared to the estimation of the mean photon counts from the detection elements of the conventional image, estimation of the mean photon counts from the detection elements of the UAIM image yields a higher quality image because the estimation can be done with higher accuracy. This can be seen by comparing the Fisher information content of a single detection element of the conventional image with the combined information content of the c pixels in the UAIM image over which the photons from the conventional detection element are distributed.

The Fisher information matrix of a single detection element of the conventional image with mean photon count ν_{θ} is given by the general expression

$${I}_{conventional} ( θ ) = {( \frac{\partial {v}_{θ}}{\partial θ} )}^{T} \frac{\partial {v}_{θ}}{\partial θ} \cdot \frac{{α}_{{v}_{θ}}}{{v}_{θ}} , \qquad [ Equation 12 ]$$

where α_{νθ} is the noise coefficient with respect to ν_{θ}, and the symbol T denotes the transpose. The noise coefficient is a nonnegative scalar with a value between 0 and 1 that indicates the amount of information the data in a pixel contains about the parameter of interest θ. The closer α_{νθ} is to 1, the greater the amount of information that the data in the pixel contains. In general, the noise coefficient for a pixel of a signal-amplifying detector is closest to 1 over a long range where its mean photon count ν_{θ} is less than 1, and approaches 0.5 as its mean photon count ν_{θ} is increased. If the signal in the single detection element is, for example, uniformly split between c detection elements, each with a reduced mean photon count of ν_{θ}/c, then the Fisher information matrix of the c detection elements combined is given by

$$\begin{matrix}{I}_{UAIM} ( θ ) = c \cdot {( \frac{\partial ( {v}_{θ} / c )}{\partial θ} )}^{T} \frac{\partial ( {v}_{θ} / c )}{\partial θ} \cdot \frac{{α}_{{v}_{θ} / c}}{{v}_{θ} / c} \\ = c \cdot \frac{1}{{c}^{2}} {( \frac{\partial {v}_{θ}}{\partial θ} )}^{T} \frac{\partial {v}_{θ}}{\partial θ} \cdot \frac{c \cdot {α}_{{v}_{θ} / c}}{{v}_{θ}} \\ = {( \frac{\partial {v}_{θ}}{\partial θ} )}^{T} \frac{\partial {v}_{θ}}{\partial θ} \cdot \frac{{α}_{{v}_{θ} / c}}{{v}_{θ}} ,\end{matrix} \qquad [ Equation 13 ]$$

where α_{νθ/c} is the noise coefficient with respect to ν_{θ}/c.

Because θ in this application is simply the mean photon count ν_{θ}, the Fisher information matrices of Equations 12 and 13 reduce to the scalars α_{νθ}/ν_{θ} and α_{νθ}/ν_{θ}, respectively. Furthermore, because a larger Fisher information matrix indicates a larger amount of information about θ=ν_{θ}, the factor of improvement in terms of the amount of information gained by splitting the signal between c detection elements is just the ratio α_{vθ/c}/α_{νθ}. For example, if α_{νθ/c}=0.9 (i.e., in the range where the noise coefficient is closest to 1) and if α_{νθ}=0.5 (i.e., in the range where the noise coefficient is closest to 0.5), then the factor of improvement is 1.8, which corresponds to a 25% reduction in the best possible standard deviation with which ν_{θ} can be estimated.

The above analysis shows that the mean photon count in a single detection element can be estimated with higher accuracy if multiple detection elements of reduced photon counts are used. By applying this method to every detection element of an image, a higher quality image is constructed.

An example of a simulation for the above approach showed that while a mean photon count of 2 in a detection element of a conventional image can be estimated with a standard deviation of 1.857, the same mean photon count uniformly distributed over 100 detection elements of a UAIM image was estimated, using the data in all 100 detection elements, with a standard deviation of 1.286. Therefore, by using UAIM, the standard deviation for estimating the mean photon count was reduced by 31%.

It is noted that forms of estimation other than maximum-likelihood estimation can be used to estimate the parameters of interest. The maximum-likelihood algorithm is an asymptotically-efficient algorithm, which is defined as an estimation algorithm that achieves the Cramer-Rao lower bound in the limit that the sample size tends to infinity. In some embodiments, any asymptotically-efficient algorithm can be used to estimate the parameters of interest. In other embodiments, the algorithm can include one or more of nonlinear least squares estimation, expectation-maximization, a maximum a posteriori probability estimator, and a Bayes estimator. The particular method or algorithm that is used in UAIM is less important than the high accuracy results that UAIM can produce. In some embodiments, the parameter estimation algorithm, irrespective of its specific nature, estimates the parameters of interest with a standard deviation that is no greater than approximately 1.5 times the square root of the Cramer-Rao lower bound. In other embodiments, the parameter estimation algorithm estimates the parameters of interest with a standard deviation that is no greater than approximately 1.3 times the square root of the Cramer-Rao lower bound. In further embodiments, the parameter estimation algorithm estimates the parameters of interest with a standard deviation that is no greater than approximately 1.2 times the square root of the Cramer-Rao lower bound. In still other embodiments, the parameter estimation algorithm estimates the parameters of interest with a standard deviation that is no greater than approximately 1.1 times the square root of the Cramer-Rao lower bound. Example algorithms that can achieve such accuracies are described below.

Experiments were conducted to demonstrate the substantial advantage that UAIM has over conventional imaging. More particularly, experiments were conducted to demonstrate the advantage of UAIM in terms of point source localization accuracy. In the experiments, images of stationary 50-nm fluorescent beads were captured using a Zeiss Axiovert 200 microscope equipped with an Andor iXon DU-897 EMCCD camera operated at an electron multiplication gain of 950 and maximum-likelihood estimation was used to determine bead positions from both UAIM and conventional EMCCD images containing on average less than 200 bead photons. Whereas a standard 63× objective lens was used to acquire the conventional images, a standard 100× objective lens was used in conjunction with three concatenated Zeiss external Optovars (two 2.5× and one 1.6×) to acquire the UAIM images with a total magnification of 1,000× to the camera.

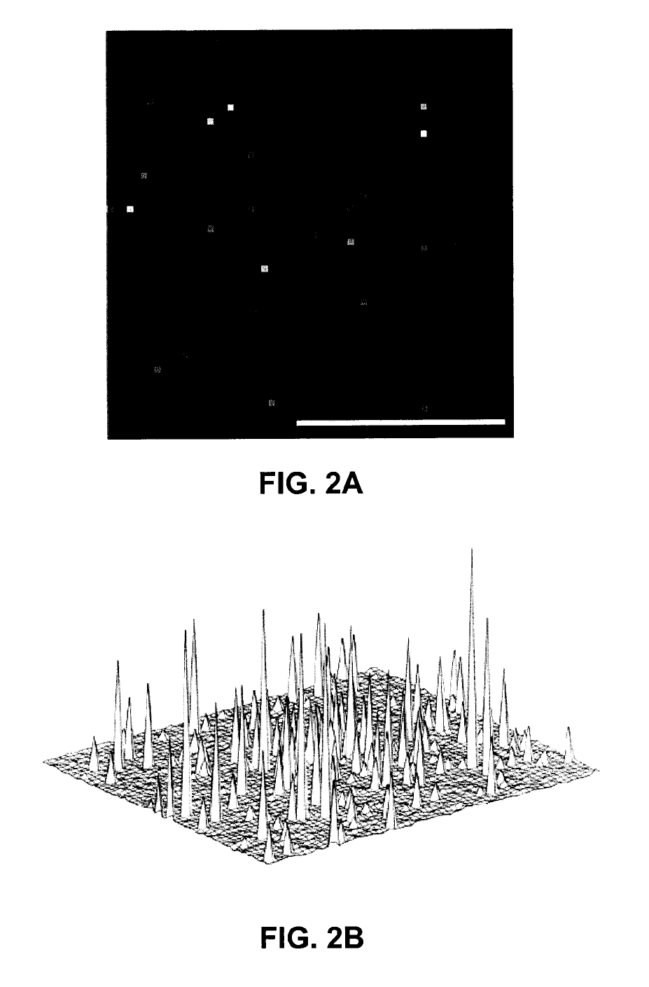

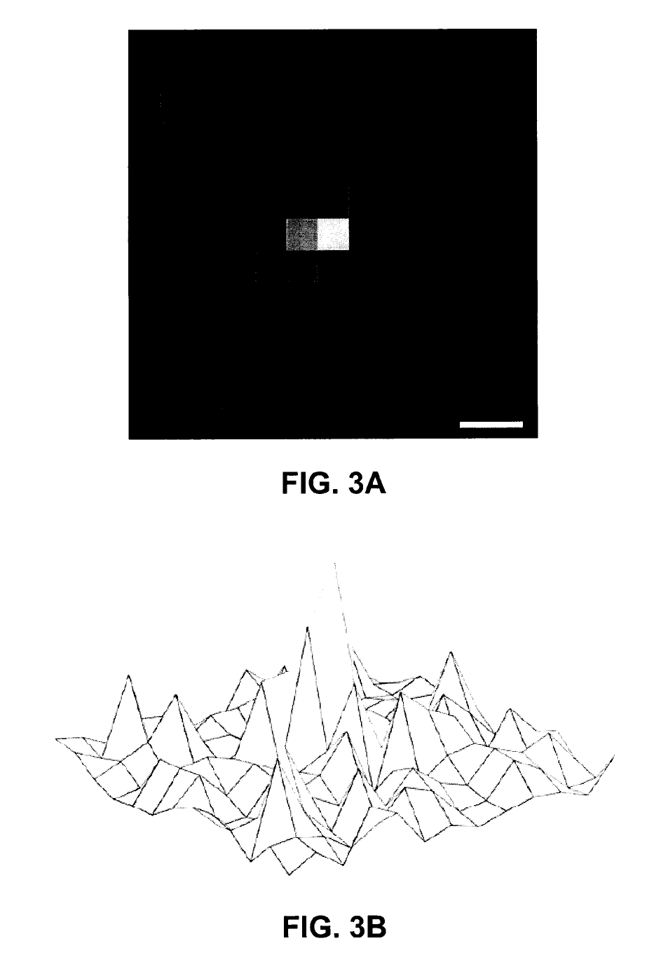

FIG. 2A shows an example UAIM image that was captured and FIG. 3A shows an example conventional image that was captured. In these figures, the scale bars in the lower right-hand corners identify a distance of 0.5 μm. Each image is that of a 50-nm fluorescent bead from which, on average, just under 80 photons per image were detected. The UAIM and conventional images were acquired with effective pixel sizes of 16 and 253.97 nm using 1,000× and 63× magnification, respectively. The mean photon count in the brightest pixel was 0.30 for the UAIM image and 16.84 for the conventional image. FIGS. 2B and 3B respectively show the UAIM and conventional images as mesh representations. The mesh representations display intensity as height and more conspicuously contrast the UAIM image (FIG. 2B) and the conventional image (FIG. 3B).

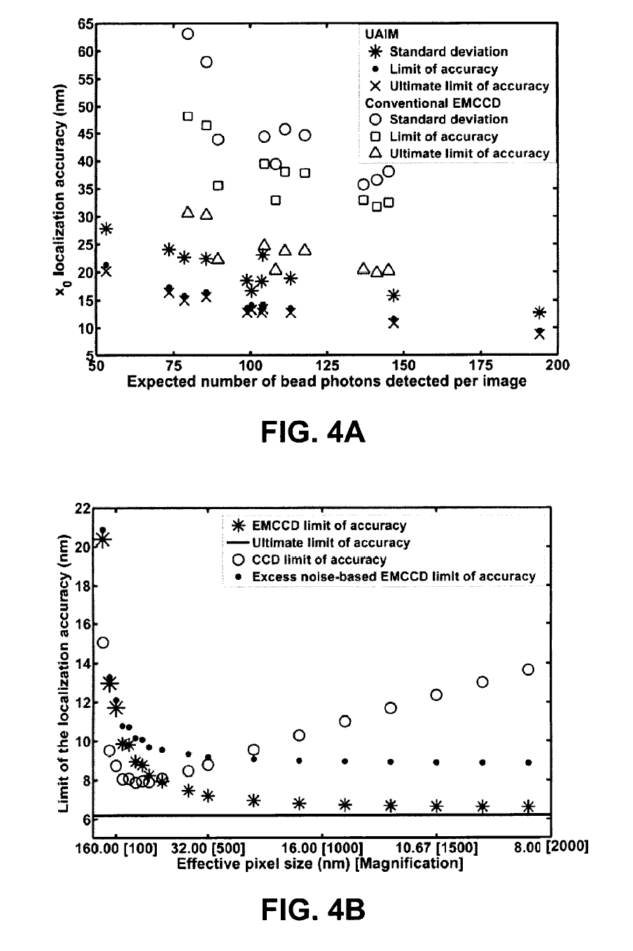

The standard deviations of the resulting estimates of the x₀ positional coordinates of different beads are plotted in FIG. 4A. Shown as a function of the mean photon counts detected per image from the beads, the standard deviations are clearly separated into a lower group that represents very high accuracies and corresponds to the beads imaged with UAIM and a higher group that represents substantially poorer accuracies and corresponds to the conventionally imaged beads. The standard deviations for the beads imaged with UAIM ranged from 27.87 to 12.70 nm over a per-image mean photon count range of 53.34 to 194.06, corresponding to a more than twofold improvement over the standard deviations for the conventionally imaged beads, which ranged from 63.11 to 38.07 nm over a per-image mean photon count range of 79.64 to 145.13.

For both UAIM and conventional EMCCD imaging, each standard deviation of x₀ estimates was compared to the corresponding theoretical best possible standard deviation (i.e., square root of the Cramer-Rao lower bound (see Equation 4 and associated discussion) for estimating x₀), or limit of accuracy, and to the corresponding ultimate limit of accuracy, which assumes an ideal detector that introduces neither noise nor pixelation, and for the ith parameter in the vector θ of parameters to be estimated, is generally given by √[I⁻¹(θ)]ᵢᵢ, where [I⁻¹(θ)]ᵢᵢ is the ith main diagonal element of the inverse of the Fisher information matrix I(θ) for the ideal image, given by

$$I ( θ ) {\int }_{{t}_{0}}^{t} {\int }_{C} \frac{{Λ}_{θ}^{2} ( τ )}{{Λ}_{θ} ( τ ) {f}_{θ , τ} + βθ ( τ ) {b}_{θ , τ} ( x , y )} {( \frac{\partial {f}_{θ , τ} ( x , y )}{\partial θ} )}^{T} \frac{\partial {f}_{θ , τ} ( x , y )}{\partial θ} d x d y d τ \qquad [ Equation 14 ]$$

where [t₀ t] is the time interval over which the ideal image was acquired, C is the finite region in R² occupied by the detector, the function Λ_{θ} gives the rate at which photons are detected from the imaged object(s) over the entire detector plane (i.e., R²), the function β_{θ} gives the rate at which background photons are detected, and the functions ƒ_{θ,τ} and b_{θ,τ} are the probability density functions that respectively describe the spatial distributions of the photons originating from the object(s) and the background photons. For both the UAIM and conventional EMCCD imaging, the standard deviations were reasonably close to their respective limits of accuracy, but only in the case of UAIM were these limits very close to their corresponding ultimate limits (FIG. 4A). UAIM therefore enabled estimation with standard deviations that approached the values one can only achieve with an ideal detector. It is noted that similar results were obtained for the localization of single Atto 647N dye molecules.

The experimental results were confirmed by carrying out maximum-likelihood estimations on simulated images of a point source. The results obtained for an ideal, a conventional EMCCD, and a UAIM data set, each comprising images of the same point source, are summarized in Table 2. Besides affirming that UAIM enables estimation with accuracies close to the ultimate limit of accuracy, these simulation results suggest that maximum-likelihood estimation is capable of attaining the limit of accuracy in all cases.

TABLE 2
Results of Maximum-Likelihood Estimation with Simulated Data

| | | | | Standard |
|---|---|---|---|---|
| | True value | Mean of | Limit of | deviation |
| | of both x₀ | x₀, y₀ | accuracy for | of x₀, y₀ |
| Imaging | and y₀ | estimates | both x₀ and y₀ | estimates |
| scenario | (nm) | (nm) | (nm) | (nm) |
| Ideal | 0 | 0.00, 0.00 | 6.19 | 6.29, 6.32 |
| Conventional | 560 | 560.02, 559.80 | 11.72 | 11.71, 12.01 |
| EMCCD | | | | |
| UAIM | 560 | 559.90, 560.53 | 6.81 | 7.04, 6.83 |

UAIM's stipulation of reducing the signal level per detection element is based on theoretical analyses that utilize a careful modeling of the EMCCD signal amplification process. These analyses indicate that, under the regime in which each EMCCD pixel generally detects fewer than one photon on average, detector noise is minimized and an image is produced that enables estimation of the quantity of interest with nearly as high an accuracy as would an image that is free of detector noise. This regime was achieved in the experiments and simulations by decreasing the effective pixel size of the detector via the use of a magnification about an order of magnitude higher (1,000× for bead images, 900× for simulated images) than what is typical, thereby distributing the detected photons over many more pixels of the detector. This approach not only minimizes the detector noise by virtue of the signal reduction per pixel but also generates a much more finely pixelated image of considerably higher resolution that more closely approximates an ideal image. By substantially reducing both major deteriorative effects of the detector, UAIM yields estimation accuracies that nearly attain the ultimate limit of accuracy. To avoid the reduced field of view that results from the use of high magnification, one can alternatively image with a standard magnification but using a nonstandard EMCCD detector with unconventionally small pixels.

FIG. 4B summarizes the results of a theoretical analysis of the effective pixel size reduction approach to implementing UAIM. As can be appreciated from that figure, as the effective pixel size is decreased, the limit of the accuracy for estimating the positional coordinate of a point source improves and approaches the ultimate limit. At an effective pixel size of just 14.55 nm (1,100× magnification), for example, UAIM yields a best possible standard deviation of 6.74 nm, which is within 1 nm of the ultimate limit of 6.19 nm. In contrast, conventional EMCCD imaging at an effective pixel size of 160 nm (100× magnification), which is within the recommended size range for fluorescence super-resolution imaging, yields a best possible standard deviation of 11.72 nm, nearly double the ultimate limit.

According to the common assertion based on the signal amplification excess noise, the best estimation accuracy achievable with an EMCCD detector is worse by a factor of √2 than that attainable with a hypothetical noiseless but pixelated detector. FIG. 4B reveals a more complex picture, demonstrating that the √2 factor indeed approximates the EMCCD limit of accuracy well at large effective pixel sizes (standard magnifications) when the mean photon count per pixel is relatively high. However, at small effective pixel sizes (high magnifications), when the mean photon count per pixel is extremely low, the √2 factor considerably underestimates the attainable accuracy, which in fact approaches the ultimate limit.

As mentioned above, a CCD detector or an sCMOS detector, especially one with a low readout noise level, can also benefit to some extent from the reduction of the effective pixel size (i.e., increase of the image resolution). For such a detector, FIG. 4B shows that compared to the use of effective pixel sizes between 400 and 160 nm (standard magnifications between 40× and 100×), better limits of accuracy are obtained by using effective pixel sizes between 160 nm and 32 nm (larger magnifications between 100× and 500×). Whereas the relatively poor limits of accuracy range from 15.05 nm to 8.75 nm for effective pixel sizes between 400 and 160 nm, the improved limits of accuracy are between 8.75 nm and 7.89 nm for effective pixel sizes between 160 nm and 32 nm.

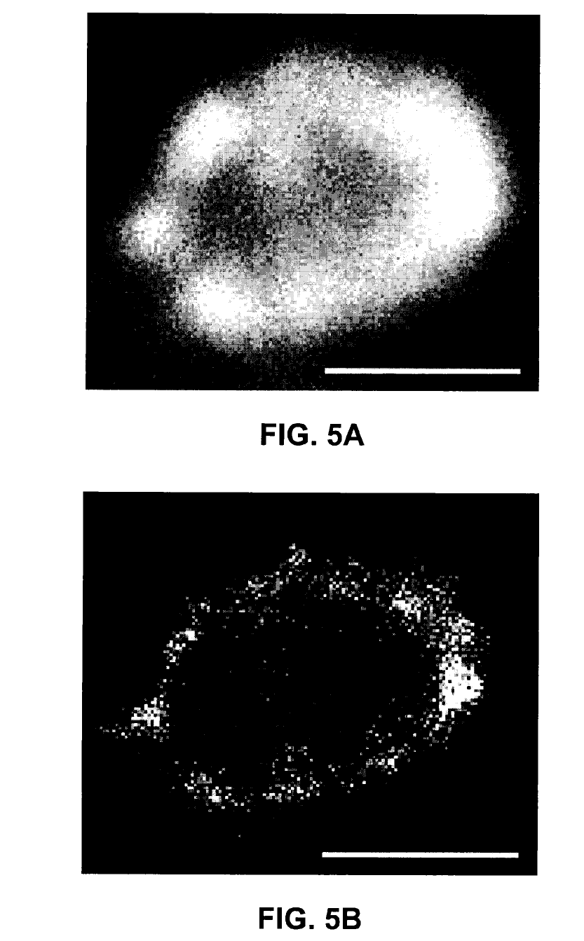

To demonstrate that UAIM can be incorporated into techniques that utilize parameter estimation, UAIM was used to perform the super-resolution imaging of an Alexa 647-labeled LAMP1⁺ cellular structure. FIG. 5A is a relatively low-resolution image of the LAMP1⁺ structure that was formed by summing 5,063 UAIM (1,000×) images of the stochastically activated Alexa 647 molecules that labeled the structure. In contrast, FIG. 5B is the super-resolution image that was constructed from the maximum-likelihood location estimates of the Alexa 647 molecules from the same 5,063 images. The average number of photons detected per molecule was 128.94. In FIGS. 5A and 5B, the scale bars represent a distance of 1 μm.

As described above, UAIM is not limited to light detectors that produce image data. UAIM can be applied to both light detectors and non-light detectors that produce data not generally regarded as images. In such cases, non-image data is captured and the elements of the detector detect something other than photons. As an example, the detector elements can detect electrons. Aside from that, however, the methods are the same.

Further embodiments of the invention are described in the article “Ultrahigh Accuracy Imaging Modality for Super-Localization Microscopy,” which was published in Nature Methods, Volume 10, No. 4, 2013 (also published online on Mar. 3, 2013). This article and all of its supplementary material is hereby incorporated by reference into the present disclosure.

1. A method for identifying a parameter of interest from captured image data, the method comprising:
capturing image data with a signal-amplifying image detector having at least one detection element in a manner in which on average fewer than approximately 10 photons are detected by each detection element; and
estimating the parameter of interest from the image data with a standard deviation that is no greater than approximately 1.5 times the square root of the Cramer-Rao lower bound.

2. The method of claim 1, wherein capturing image data comprises capturing image data in a manner in which on average fewer than approximately 5 photons are detected by each detection element.

3. The method of claim 1, wherein capturing image data comprises capturing image data in a manner in which on average fewer than approximately 3 photons are detected by each detection element.

4. The method of claim 1, wherein capturing image data comprises capturing image data in a manner in which on average fewer than approximately 1 photon is detected by each detection element.

5. The method of claim 1, wherein capturing image data comprises intentionally reducing the number of photons detected by the detection elements.

6. The method of claim 5, wherein reducing the number of photons comprises using high magnification to spread out the photons over the elements of the detector.

7. The method of claim 5, wherein reducing the number of photons comprises using a light detector having unconventionally small detection elements to ensure that each element only detects a small number of photons.

8. The method of claim 5, wherein reducing the number of photons comprises capturing multiple images in succession to temporally distribute the photons and ensure that each element of each image only detects a small number of photons.

9. The method of claim 5, wherein reducing the number of photons comprises simultaneously acquiring multiple images of an object using multiple light detectors.

10. The method of claim 4, wherein reducing the number of photons comprises acquiring multiple images of an object using multiple light detectors.

11. The method of claim 1, wherein estimating the parameter of interest comprises estimating the parameter interest of with a standard deviation that is no greater than approximately 1.3 times the square root of the Cramer-Rao lower bound.

12. The method of claim 1, wherein estimating the parameter of interest comprises estimating the parameter of interest with a standard deviation that is no greater than approximately 1.2 times the square root of the Cramer-Rao lower bound.

13. The method of claim 1, wherein estimating the parameter of interest comprises estimating the parameter of interest with a standard deviation that is no greater than approximately 1.1 times the square root of the Cramer-Rao lower bound.

14. The method of claim 1, wherein estimating the parameter of interest comprises estimating the parameter using an asymptotically efficient algorithm.

15. The method of claim 1, wherein estimating the parameter of interest comprises estimating the parameter using maximum-likelihood estimation, nonlinear least squares estimation, expectation-maximization, a maximum a posteriori probability estimator, or a Bayes estimator.

16. The method of claim 1, wherein using an algorithm to estimate the parameter of interest comprises using a maximum-likelihood algorithm.

17. The method of claim 16, wherein the maximum-likelihood algorithm can be described as the maximization of the log-likelihood function
$$ln ( L ( θ \vert {z}_{1} , … , {z}_{K} ) ) = {\sum }_{k = 1}^{K} ln ( {p}_{θ , γ , k} ( {z}_{k} ) ) ,$$
where θ is the scalar or vector parameter to be estimated, and for k=1, . . . , K, zₖ is the data at the kth detection element and p_{θ,γ,k} is the probability density function of zₖ that is dependent on detector γ which contains the kth detection element, wherein the θ that maximizes the right-hand side of the equation identifies the best estimate of the parameter.

18. The method of claim 1, wherein estimating a parameter of interest comprises estimating a location of an object.

19. The method of claim 1, wherein estimating a parameter of interest comprises estimating a distance between two objects.

20. The method of claim 1, wherein estimating a parameter of interest comprises estimating a trajectory of an object.

21. The method of claim 1, wherein estimating a parameter of interest comprises estimating a statistic of photon counts detected by the detection elements for the purpose of producing a high-quality image.

22. A system for identifying a parameter of interest from captured image data, the system comprising:
a signal-amplifying light detector having at least one detection element;
a processing device; and
memory that stores a parameter estimation algorithm that is configured to:
receive image data that results when the detection elements detect on average fewer than approximately 10 photons each, and
estimate the parameter of interest from the image data with a standard deviation that is no greater than approximately 1.5 times the square root of the Cramer-Rao lower bound.

23. The system of claim 22, wherein the light detector is an electron-multiplying charge-coupled device (EMCCD) detector.

24. The system of claim 22, wherein the parameter estimation algorithm is configured to receive image data that results when the detection elements detect on average fewer than approximately 1 photon each.

25. The system of claim 22, wherein the parameter estimation algorithm is an asymptotically efficient algorithm.

26. The system of claim 22, wherein the parameter estimation algorithm is a maximum-likelihood algorithm, a nonlinear least squares estimation algorithm, an expectation-maximization algorithm, a maximum a posteriori probability estimator, or a Bayes estimator.

27. The system of claim 22, wherein the parameter estimation algorithm is a maximum-likelihood algorithm.

28. The system of claim 27, wherein the maximum-likelihood algorithm can be described as the maximization of the log-likelihood function
$$ln ( L ( θ \vert {z}_{1} , … , {z}_{K} ) ) = {\sum }_{k = 1}^{K} ln ( {p}_{θ , γ , k} ( {z}_{k} ) ) ,$$
where θ is the scalar or vector parameter to be estimated, and for k=1, . . . , K, zₖ is the data at the kth detection element and p_{θ,γ,k} is the probability density function of zₖ that is dependent on detector γ which contains the kth detection element, wherein the θ that maximizes the right-hand side of the equation indicates the best estimate of the parameter.

29. A non-transitory computer-readable medium that stores a parameter estimation algorithm comprising:
logic configured to receive image data that results from detection elements of a signal-amplifying light detector detecting on average fewer than approximately 10 photons each, and
logic configured to estimate the parameter of interest from the image data with a standard deviation that is no greater than approximately 1.5 times the square root of the Cramer-Rao lower bound.

30. The computer-readable medium of claim 29, wherein the parameter estimation algorithm comprises logic configured to receive image data that results when the detection elements detect on average fewer than approximately 1 photon each.

31. The computer-readable medium of claim 29, wherein the parameter estimation algorithm is an asymptotically efficient algorithm.

32. The computer-readable medium of claim 29, wherein the parameter estimation algorithm is a maximum-likelihood algorithm, a nonlinear least squares estimation algorithm, an expectation-maximization algorithm, a maximum a posteriori probability estimator algorithm, or a Bayes estimator algorithm.

33. The computer-readable medium of claim 29, wherein the parameter estimation algorithm is a maximum-likelihood algorithm.

34. The computer-readable medium of claim 33, wherein the maximum-likelihood algorithm can be described as the maximization of the log-likelihood function
$$ln ( L ( θ \vert {z}_{1} , … , {z}_{K} ) ) = {\sum }_{k = 1}^{K} ln ( {p}_{θ , γ , k} ( {z}_{k} ) ) ,$$
where θ is the scalar or vector parameter to be estimated, and for k=1, . . . , K, zₖ is the data at the kth detection element and p_{θ,γ,k} is the probability density function of zₖ that is dependent on detector γ which contains the kth detection element, wherein the θ that maximizes the right-hand side of the equation indicates the best estimate of the parameter.

35. A method for identifying a parameter of interest from captured image data, the method comprising:
imaging an object with a light microscope at a magnification of at least 200×;
capturing image data of the object with a non-signal-amplifying light detector associated with the light microscope; and
estimating the parameter of interest from the image data with a standard deviation that is no greater than approximately 1.5 times the square root of the Cramer-Rao lower bound.

36. The method of claim 35, wherein estimating the parameter of interest comprises estimating the parameter of interest with a standard deviation that is no greater than approximately 1.3 times the square root of the Cramer-Rao lower bound.

37. The method of claim 35, wherein estimating the parameter of interest comprises estimating the parameter of interest with a standard deviation that is no greater than approximately 1.2 times the square root of the Cramer-Rao lower bound.

38. The method of claim 35, wherein estimating the parameter of interest comprises estimating the parameter of interest with a standard deviation that is no greater than approximately 1.1 times the square root of the Cramer-Rao lower bound.

39. The method of claim 35, wherein estimating the parameter of interest comprises estimating the parameter using an asymptotically efficient algorithm.

40. The method of claim 35, wherein estimating the parameter of interest comprises estimating the parameter using maximum-likelihood estimation, nonlinear least squares estimation, expectation-maximization, a maximum a posteriori probability estimator, or Bayes estimator.

41. The method of claim 35, wherein using an algorithm to estimate the parameter of interest comprises using a maximum-likelihood algorithm.

42. The method of claim 41, wherein the maximum-likelihood algorithm can be described as the maximization of the log-likelihood function
$$ln ( L ( θ \vert {z}_{1} , … , {z}_{K} ) ) = {\sum }_{k = 1}^{K} ln ( {p}_{θ , γ , k} ( {z}_{k} ) ) ,$$
where θ is the scalar or vector parameter to be estimated, and for k=1, . . . , K, zₖ is the data at the kth detection element and p_{θ,γ,k} is the probability density function of zₖ that is dependent on detector γ which contains the kth detection element, wherein the θ that maximizes the right-hand side of the equation indicates the best estimate of the parameter.

43. A system for identifying a parameter of interest from captured image data, the system comprising:
a light microscope having a magnification of at least 200×;
a non-signal amplifying light detector associated with the microscope, the detector being configured to capture image data of an object imaged with the light microscope;
a processing device; and
memory that stores a parameter estimation algorithm that is configured to estimate the parameter of interest from the image data with a standard deviation that is no greater than approximately 1.5 times the square root of the Cramer-Rao lower bound.

44. The system of claim 43, wherein the non-signal-amplifying light detector is a charge-coupled device (CCD) detector.

45. The system of claim 43, wherein the non-signal-amplifying light detector is a scientific complementary metal-oxide semiconductor (sCMOS) detector.

46. The system of claim 43, wherein the parameter estimation algorithm is an asymptotically efficient algorithm.

47. The system of claim 43, wherein the parameter estimation algorithm is a maximum-likelihood algorithm, a nonlinear least squares estimation algorithm, an expectation-maximization algorithm, a maximum a posteriori probability estimator, or a Bayes estimator.

48. The system of claim 43, the parameter estimation algorithm is a maximum-likelihood algorithm.

49. The system of claim 48, wherein the maximum-likelihood algorithm can be described as the maximization of the log-likelihood function
$$ln ( L ( θ \vert {z}_{1} , … , {z}_{K} ) ) = {\sum }_{k = 1}^{K} ln ( {p}_{θ , γ , k} ( {z}_{k} ) ) ,$$
where θ is the scalar or vector parameter to be estimated, and for k=1, . . . , K, zₖ is the data at the kth detection element and p_{θ,γ,k} is the probability density function of zₖ that is dependent on detector γ which contains the kth detection element, wherein the θ that maximizes the right-hand side of the equation indicates the best estimate of the parameter.
